(19) United States
(12) Patent Application Publication
(10) Pub. No.: US 2026/0036885 A1
(43) Pub. Date: Feb. 5, 2026

(54) CAMERA STRUCTURE

(71) Applicant: Luxshare Intelligent Manufacture Technology (Changshu) Co., Ltd, Changshu City (CN)

(72) Inventors: Po-Ying TSENG, Taipei City (TW); Li-Jhen CHEN, Taipei City (TW); Ngoc-Luong NGUYEN, Changshu City (CN)

(73) Assignee: Luxshare Intelligent Manufacture Technology (Changshu) Co., Ltd, Changshu City (CN)

(21) Appl. No.: 19/284,363

(22) Filed: Jul. 29, 2025

(30) Foreign Application Priority Data
Jul. 30, 2024 (CN) 202411034626.4

(51) Int. Cl. G03B 17/12; G02B 7/09; G02B 27/64

(52) U.S. Cl. CPC G03B 17/12; G02B 7/09; G02B 27/646

(57) ABSTRACT

A camera structure includes a moving structure and an imaging lens. The moving structure includes a first moving portion, a second moving portion, and a moving element. The moving element is disposed between the first moving portion and the second moving portion. The moving element includes two opposite end portions and an external surface positioned there between. The external surface is an arc surface. The first moving portion has a first surface and the second moving portion has a second surface. The external surface of the moving element abuts against the first surface and the second surface respectively. The moving structure is configured such that, when the first moving portion and the second moving portion are displaced relative to each other, the moving element moves along the first surface and the second surface. The imaging lens is displaced by the moving structure.

### CROSS REFERENCE TO RELATED APPLICATION

This application claims the priority benefit of Chinese Patent Application Serial Number 202411034626.4, filed on Jul. 30, 2024, the full disclosure of which is incorporated herein by reference.

### BACKGROUND

### 1. Technical Field

The present invention relates to the technical field of camera technology, particularly to a camera structure.

### 2. Description of the Related Art

Camera devices typically include anti-shake mechanisms. When a user holds a camera for capturing images, there may be unstable shaking or vibrations due to hand movements, which can affect the quality of the captured image. Optical anti-shake technology can compensate for these movements in the light of the image, resulting in high-quality captured images. However, conventional technology uses ball-type anti-shake designs, where balls roll within a V-shaped groove. The balls make multiple point contacts with the V-shaped groove. These point contacts not only have a small contact area but also tend to concentrate stress at the contact point. As a result, the stress from the ball's point contact can significantly impact the accommodating groove or structural surface. Over time, this can lead to severe friction, debris accumulation, and other issues such as contamination and abnormal wear.

### SUMMARY

In some embodiments of the present invention, a camera structure includes a moving structure and an imaging lens. The moving structure includes a first moving portion, a second moving portion, and a moving element, with the moving element disposed between. The moving element includes two opposite end portions and an external surface located between the two end portions. The long axis of the moving element passes through the two end portions. The external surface surrounds the long axis and the external surface is a curved surface. The first moving portion has a first surface and the second moving portion has second surface. The external surface of the moving element respectively abuts against the first surface and the second surface. The moving structure is configured such that, when the first moving portion and the second moving portion are displaced relative to each other, the moving element moves along the first surface and the second surface, and the imaging lens is displaced through the moving structure.

In one embodiment of the present invention, at least one of the first surface and the second surface is a plane, an arc surface based on a side profile of the external surface of the moving element, or a polygonal concave surface based on the side profile of the external surface of the moving element.

In one embodiment of the present invention, the polygonal concave surface has multiple contact surfaces relative to the moving element.

In one embodiment of the present invention, at least one of the first surface and the second surface parallel to the long axis of the moving element.

In one embodiment of the present invention, the first surface and the second surface are symmetrical with the long axis of the moving element.

In one embodiment of the present invention, the camera structure further includes a base assembly and a first moving assembly, the first moving assembly is disposed within the base assembly, and the moving structure includes a first moving structure. The first moving structure is positioned between an inner wall of the base assembly corresponding to the outer wall of the first moving assembly. The base assembly has a first moving portion and the first moving assembly has a second moving portion. The first moving structure guides the first moving assembly to move reciprocally in a first direction relative to the base assembly.

In one embodiment of the present invention, the base assembly includes a base and a first coil. The first coil is disposed on the base. The first moving assembly includes a first moving body and a first magnet. The first magnet is disposed on the first moving body and the first coil corresponds to the first magnet. A magnetic pole of the first magnet is parallel to the first direction.

In one embodiment of the present invention, the base has a base accommodation concave slot and the slot side wall of the base accommodation concave slot has a first notch. The first coil is positioned within the first notch. The first moving body has a first accommodation trough, and the first magnet is disposed within the first accommodation trough. A position of the first notch corresponds to the position of the first accommodation trough.

In one embodiment of the present invention, the camera structure further includes a second moving assembly and the moving structure includes a second moving structure. The first moving assembly has an accommodation concave slot. The second moving assembly is disposed within the accommodation concave slot of the first moving assembly. The second moving structure is positioned between the accommodation concave slot of the first moving assembly corresponding to the bottom portion of the second moving assembly. The first moving assembly has a first moving portion and the second moving assembly has a second moving portion. The second moving structure guides the second moving assembly to move reciprocally in a second direction relative to the first moving assembly, and the second direction and the first direction are perpendicular to each other.

In one embodiment of the present invention, the camera structure further includes a lens base assembly and the moving structure includes a third moving structure. The lens base assembly is disposed on the second moving assembly. The third moving structure is positioned between a top portion of the second moving assembly and corresponds to the bottom portion the lens base assembly. The second moving assembly has a first moving portion and the lens base assembly has a second moving portion. The third moving structure guides the lens base assembly to move reciprocally in a third direction relative to the second moving assembly, and the third direction and the second direction are perpendicular to each other.

In one embodiment of the present invention, the imaging lens is disposed on the lens base assembly.

In one embodiment of the present invention, the base assembly includes a base and a second coil. The second coil is disposed on the base. The lens base assembly includes a lens base and a second magnet. The second magnet is disposed on the lens base. The second magnet corresponds to the second coil and the magnetic pole direction of the second magnet is parallel to the second direction.

In one embodiment of the present invention, the base has a base accommodation concave slot and the slot side wall of the base accommodation concave slot further has second notch. The second coil is positioned within the second notch and the lens base has a second accommodation trough. The second magnet is disposed within the second accommodation trough and a position of the second notch corresponds to a position of the second accommodation trough.

In one embodiment of the present invention, the base assembly includes a base and a third coil, the third coil is disposed on the base, and the lens base assembly includes a lens base and a third magnet. The third magnet is disposed on the lens base and the third magnet corresponds to the third coil. The magnetic pole direction of the third magnet is parallel to the third direction.

In one embodiment of the present invention, the base has a base accommodation concave slot, and the slot side wall of the base accommodation concave slot further has a third notch. The third coil is positioned within the third notch and the lens base has a third accommodation trough. The third magnet is disposed on the third accommodation trough, and the position of the third notch corresponds to the position of the third accommodation trough.

In one embodiment of the present invention, the camera structure further includes a spring plate. The spring plate is disposed on the first moving assembly and abuts against the top of the lens base assembly.

In one embodiment of the present invention, the spring plate is arranged along the side of the first moving assembly, and the side of the spring plate extends downward to a fixing part. The first moving assembly has a corresponding fixed trough, and the fixing part of the spring plate is fixed within the fixed trough of the first moving assembly correspondingly.

In one embodiment of the present invention, the camera structure further includes a circuit board. The circuit board is disposed on a side of the base assembly. The circuit board is electrically connected to the first coil, the second coil, and the third coil respectively.

### BRIEF DESCRIPTION OF THE DRAWINGS

The accompanying drawings described here are provided to facilitate a further understanding of the present invention and constitute a part of this application. The illustrative embodiments and their descriptions are used to explain the present invention and do not constitute undue limitations on it. In the drawings:

FIG. 1 is a perspective view of the camera structure of an embodiment of the present invention;

FIG. 2 is a sectional view along line A-A′ of FIG. 1;

FIG. 3 is an enlarged view of area D in FIG. 2;

FIG. 4 is a sectional view along line B-B′ of FIG. 1B-B′;

FIG. 5 is a sectional view along line C-C′ of FIG. 1;

FIG. 6 is a partially exploded perspective view of the first embodiment of the camera structure of the present invention;

FIG. 7 is an enlarged view of area E in FIG. 6;

FIG. 8 is a partially exploded perspective view of the first embodiment of the camera structure of the present invention;

FIG. 9 is another partially exploded perspective view of the first embodiment of the camera structure of the present invention;

FIG. 10 is an exploded perspective view of the first embodiment of the camera structure of the present invention;

FIG. 11 is a schematic view of the second embodiment of the camera structure of the present invention;

FIG. 12 is a schematic view of the third embodiment of the camera structure of the present invention;

FIG. 13 is a schematic view of the fourth embodiment of the camera structure of the present invention;

FIG. 14 is a schematic view of the fifth embodiment of the camera structure of the present invention;

FIG. 15 is a schematic view of the sixth embodiment of the camera structure of the present invention; and

FIG. 16 is a schematic view of the seventh embodiment of the camera structure of the present invention.

Descriptions in conjunction with the drawings are as follows: 1: camera structure; 11, 11A, 11B, 11C: moving structure; 111, 111A, 111B, 111C: first moving portion; 1111: first surface; 112, 112A, 112B, 112C: second moving portion; 1121: second surface; 113, 113A, 113B, 113C: moving element; 1131: end portion; 1132: external surface; 12: imaging lens; 13: base assembly; 131: base; 1310: base accommodation concave slot; 1311: first notch; 1312: second notch; 1313: third notch; 132: first coil; 133: second coil; 134: third coil; 14: first moving assembly; 140: accommodation concave slot; 141: first moving body; 1411: first accommodation trough; 142: first magnet; 143: fixed trough; 15: second moving assembly; 16: lens base assembly; 161: lens base; 1611: second accommodation trough; 1612: third accommodation trough; 162: second magnet; 163: third magnet; 17: circuit board; 18: spring plate; 181: fixing part; Z: first direction; Y: second direction; X: third direction; C: long axis; 10P, 30P: bottom surface; 11P, 31P: inclined plane; 20P: bottom surface; 21P: first inclined plane; 22P: second inclined plane.

### DETAILED DESCRIPTION OF THE EMBODIMENTS

The following drawings disclose multiple embodiments of the present invention. For the sake of clarity, many implementation details will be described in the following narration. However, it should be understood that these implementation details should not be used to limit the present invention. That is to say, in some embodiments of the present invention, these implementation details are not essential. Additionally, for the sake of simplicity in the drawings, some conventional structures and components will be illustrated in a simplified and schematic manner. In the following embodiments, the same reference numerals will be used to denote the same or similar components.

In some embodiments of the present invention, a camera structure utilizes an elliptical moving element in conjunction with the rolling of a first moving portion and a second moving portion to address the friction problems caused by excessive stress from the point contacts of conventional balls.

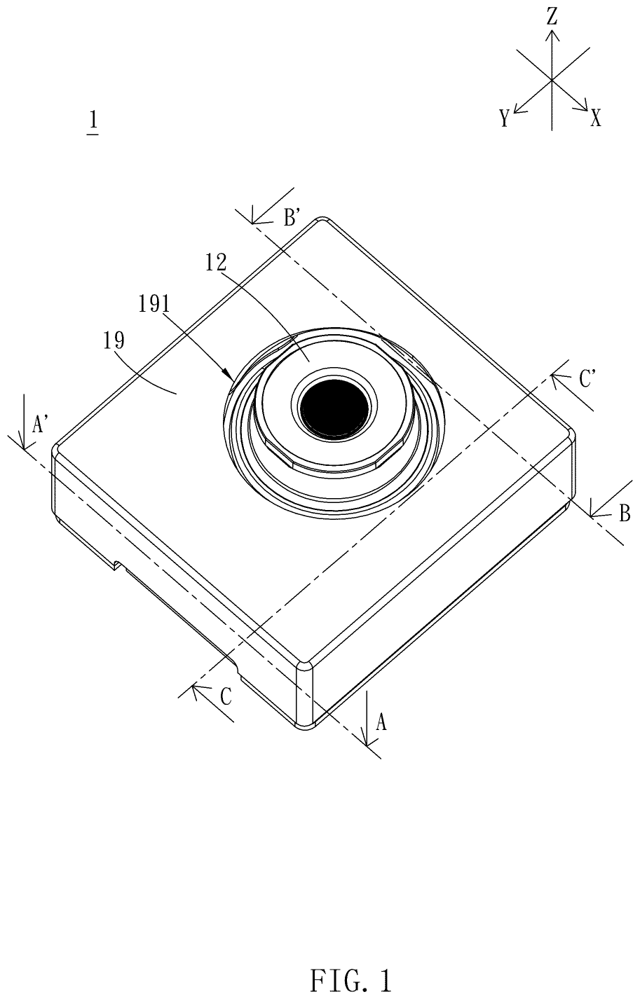

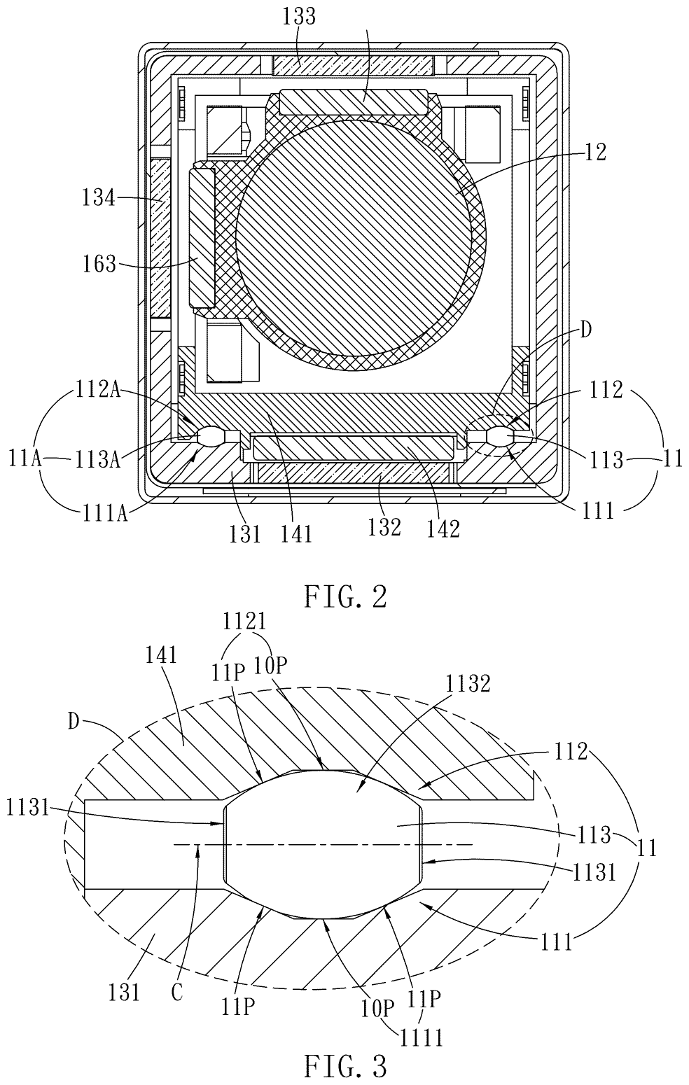

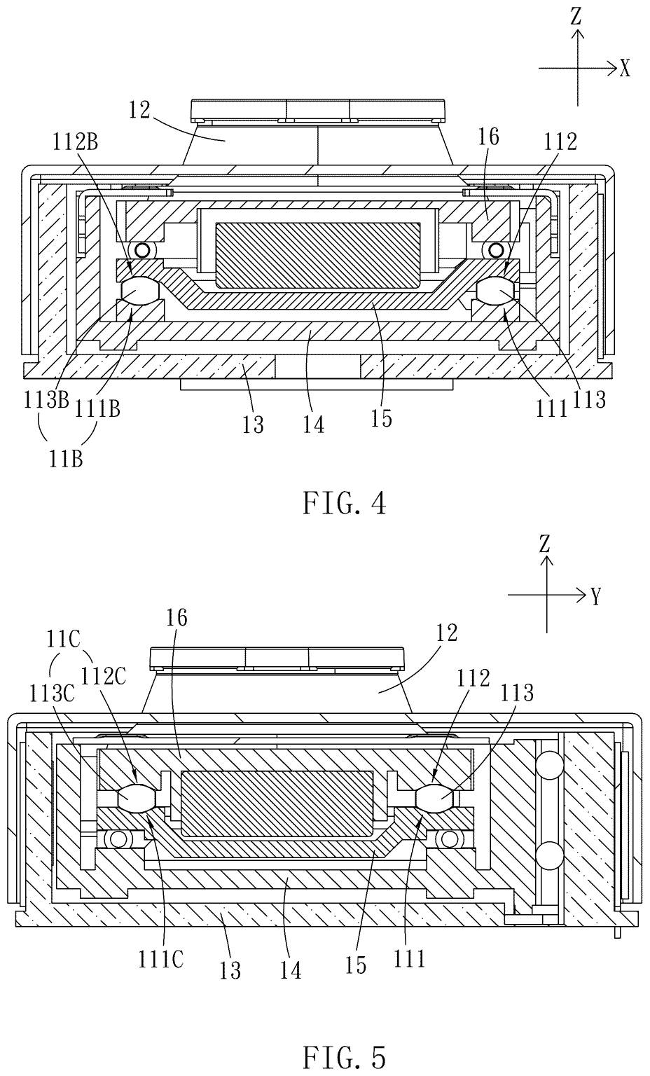

Please refer to FIG. 1 to FIG. 5. FIG. 1 is a perspective view of the camera structure of the present invention, FIG. 2 is a sectional view along line A-A′ of FIG. 1, FIG. 3 is an enlarged view of area D in FIG. 2, FIG. 4 is a sectional view along line B-B′ of FIG. 1B-B′, and FIG. 5 is a sectional view along line C-C′ of FIG. 1. As shown in FIG. 1 to FIG. 5, the present invention provides a camera structure 1 including a moving structure 11 and an imaging lens 12. The moving structure 11 includes a first moving portion 111, a second moving portion 112, and a moving element 113. The moving element 113 is disposed between the first moving portion 111 and the second moving portion 112. The moving element 113 includes two opposite end portions 1131 and an external surface 1132 is located between the two end portions 1131. The long axis C of the moving element 113 passes through the two end portions 1131 and the external surface 1132 surrounds the long axis C, wherein the external surface is a curved surface. In some embodiments, along the direction of the long axis C, the external surface 1132 gradually extends away from the long axis C from the two end portions 1131 to the middle position between the two end portions. In some embodiments, along the direction of the long axis C, the curvature of the external surface 1132 is smaller than that of a circle. The first moving portion 111 has a first surface 1111 and the second moving portion 112 has a second surface 1121. The external surface 1132 of the moving element 113 abuts against the first surface 1111 and the second surface 1121 respectively. The first moving portion 111 and the second moving portion 112 are displaced relative to each other and the moving element 113 moves along the first surface 1111 and the second surface 1121. The imaging lens 12 is displaced through the moving structure 11. The moving structure 11 of this embodiment can provide the imaging lens 12 with the function of auto-focus (AF) and/or optical image stabilization (OIS). In some embodiments, the moving element 113, when viewed as a whole, may approximate an ellipsoid or football-like shape, belonging to non-spherical or non-cylindrical shapes, but the external surface 1132 of the moving element 113 has a curved or arc-like shape. In some embodiments, when the first moving portion 111 and the second moving portion 112 are displaced relative to each other, the moving element 113 rolls on the first surface 1111 and the second surface 1121. In some embodiments, the two end portions 1131 are circular flat surfaces.

Please refer to FIG. 3. In this embodiment, the first surface 1111 of the first moving portion 111 and the second surface 1121 of the second moving portion 112 are polygonal concave surfaces according to the side profile of the external surface 1132 of the moving element 113, wherein the polygonal concave surfaces have multiple contact points relative to the moving element 113. In some embodiments, a portion of the polygonal concave surface of the first surface 1111 is parallel to the long axis C of the moving element 113 and a portion of the polygonal concave surface of the second surface 1121 is parallel to the long axis C of the moving element 113. In some embodiments, the first surface 1111 and the second surface 1121 are also symmetrical with the long axis C of the moving element 113. In this embodiment, the first surface 1111 and the second surface 1121 each comprise a bottom surface 10P on both sides of the inclined plane 11P, wherein the angle between the bottom surface 10P and the inclined plane 11P is an obtuse angle, and the bottom surface 10P is parallel to the long axis C of the moving element 113. The bottom surface 10P and the two inclined planes 11P of the first surface 1111 or the second surface 1121 form a polygonal concave surface based on the side profile of the moving element 113. Therefore, the external surface 1132 of the moving element 113 has corresponding contact points with the bottom surface 10P and/or the two inclined planes 11P of the first surface 1111 or the second surface 1121. That is, there are six contact points between the peripheral surface 1132 and the first surface 1111 as well as the second surface 1121. In this embodiment, the external surface 1132 of the moving element 113 has corresponding contact points with the bottom surface 10P and the two inclined planes 11P of the first surface 1111 and second surface 1121. That is, there are six contact points between the external surface 1132 and the first surface 1111 as well as the second surface 1121. In some embodiments, when both sides of the moving element 113 are in contact with the first surface 1111 and the second surface 1121, the contact points where the moving element 113 touches the first surface 1111 or the second surface 1121 may undergo shape changes due to stress. In other words, as shown in the cross-sectional view in FIG. 3, the original point contact between the first surface 1111 and the second surface 1121 with the external surface 1132 will, due to deformation, conform more to the contour of the external surface 1132. This causes the original point contact to change to line contact. In this embodiment, from a cross-sectional perspective, the contact points between the first surface 1111 and the second surface 1121 with the external surface 1132 appear as line contacts, while in the actual three-dimensional state, they form surface contacts. The bottom surface 10P and the two inclined planes 11P of the first surface 1111 deformed by the contact with the moving element 113 respectively form curved surfaces. The contact area of the first surface 1111 is the sum of these curved surface areas. Similarly, the bottom surface 10P and the two inclined planes 11P of the second surface 1121, deformed by the contact with the moving element 113, respectively form curved surfaces, and the contact area of the second surface 1121 is the sum of these curved surface areas.

In this embodiment, a comparison is made between the moving element 113 and a spherical ball installed between the first surface 1111 and the second surface 1121, using the ball's diameter as an example, which is the same as the minor axis length of the moving element 11. The curvature of the external surface 1132 of the moving element 113 is smaller than the surface curvature of the spherical ball. Therefore, the contact surface between the external surface 1132 of the moving element 113 and the first surface 1111 as well as the second surface 1121 is larger than the contact surface between the spherical ball and the first surface 1111 and the second surface 1121. The contact points between the external surface 1132 of the moving element 113 and the first surface 1111 as well as the second surface 1121 are not concentrated at a single point. Instead, they are distributed according to the position of the bottom surface 10P and the two inclined planes 11P. As a result, the stress on the moving element 113 is less likely to be concentrated at a single point and the stress of the moving element 113 can be dispersed across the external surface 1132. Thus, the moving element 113 can avoid a significant stress friction effect on the first surface 1111 or the second surface 1121. In contrast, a ball has a defined center point on a contact surface, and the stress on the ball tends to be concentrated at this point, resulting in higher friction with the surfaces.

Furthermore, as the pressure applied by the moving element 113 to the first surface 1111 and the second surface 1121 increases, the contact area on the first surface 1111 and the second surface 1121 also increases. As the pressure applied by the moving element 113 and the ball increases, the increase in the contact area on the first surface 1111 and the second surface 1121 pressed by the moving element 113 is greater compared to the increase in the contact area on these surfaces if pressed by a ball. The amount of shape change required for the first surface 1111 and the second surface 1121 relative to the moving element 113 does not need to be large. The first surface 1111 can provide sufficient support to fix the moving element 113 in place, making it less likely for the moving element 113 to experience sliding friction against the first surface 1111 and the second surface 1121. This can help extend the lifespan of the moving structure 11. In some embodiments, the element that undergoes deformation under pressure can be the opposite. For example, the element that deforms under pressure could be the external surface 1132 of the moving element 113 rather than the first surface 1111 and the second surface 1121. In this case, the hardness of the external surface 1132 of the moving element 113 is less than those of the first surface 1111 and the second surface 1121. When the external surface 1132 contacts the first surface 1111 and the second surface 1121, the external surface 1132 undergoes local deformation due to the forces from the first surface 1111 and the second surface 1121. At this time, the contact surface where the external surface 1132 of the moving element 113 is deformed by the bottom surface 10P and the inclined plane 11P of the first surface 1111 and the second surface 1121 is a plane. In some embodiments, the element undergoing deformation under pressure can be the external surface 1132, the first surface 1111, and the second surface 1121 simultaneously.

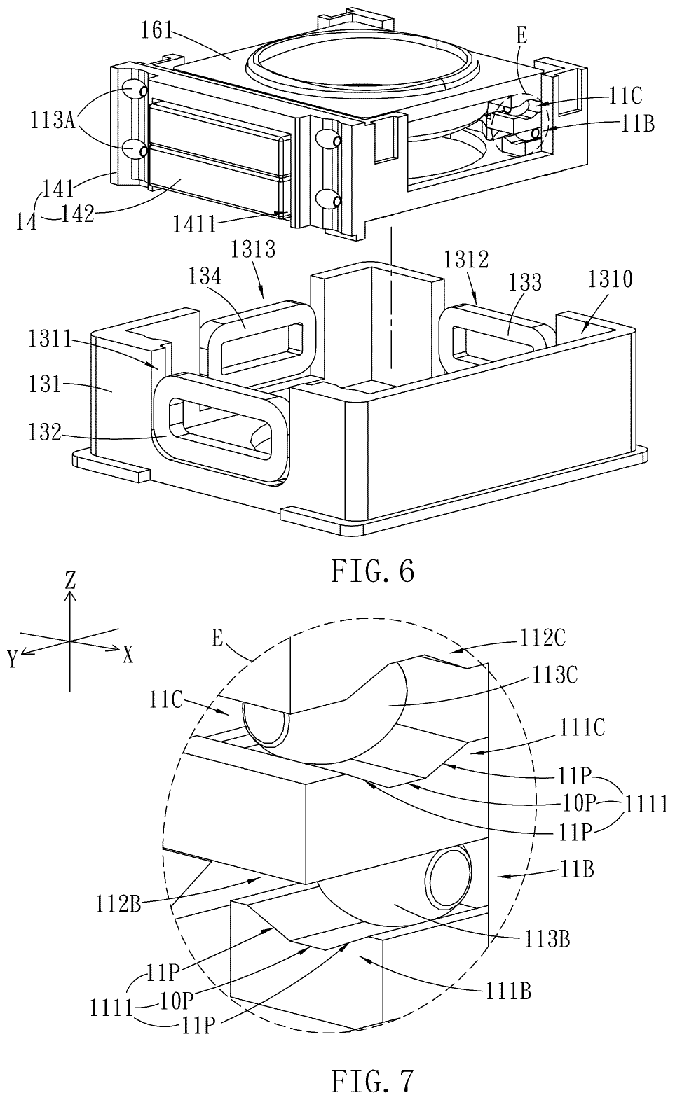

Please refer to FIG. 6. FIG. 6 is a partially exploded perspective view of the first embodiment of the camera structure of the present invention. As shown in FIG. 6, in this embodiment, the camera structure 1 further includes a base assembly 13 and a first moving assembly 14. The first moving assembly 14 is positioned within the base assembly 13. The moving structure 11 includes a first moving structure 11A. A first moving structure 11A is positioned between the inner wall of the base assembly 13 corresponding to the outer wall of the first moving assembly 14. The base assembly 13 has a first moving portion 111A and the first moving assembly 14 has a second moving portion 112A. A moving element 113A is disposed between the first moving portion 111A and the second moving portion 112A. The moving element 113 in this embodiment is multiple. The multiple moving elements 113 are situated at two sides of the camera structure 1. The multiple moving elements 113 are arranged along the first direction Z between the base assembly 13 and the first moving assembly 14. The first moving structure 11A guides the first moving assembly 14 to move reciprocally in the first direction Z (the vertical direction) relative to the base assembly 13.

Furthermore, the base assembly 13 includes a base 131 and a first coil 132. The first coil 132 is disposed on the base 131. The first moving assembly 14 includes a first moving body 141 and a first magnet 142. The first magnet 142 is disposed on the first moving body 141 and the first coil 132 corresponds to the first magnet 142. The magnetic pole direction of the first magnet 142 is parallel to the first direction Z. The base 131 has a base accommodation concave slot 1310, and the slot side wall of the base accommodation concave slot 1310 has a first notch 1311. The first coil 132 is positioned in the first notch 1311. The first moving body 141 has a first accommodation trough 1411. The first magnet 142 is disposed within the first accommodation trough 1411. A position of the first notch 1311 corresponds to the position of the first accommodation trough 1411.

As described above, the magnetic pole direction of the first magnet 142 is arranged parallel to the first direction Z; i.e., the S pole and the N pole of the magnetic pole are aligned in the vertical direction. When current passes through the first coil 132 and generates a corresponding magnetic field, the magnetic field of the first coil 132 interacts with the magnetic poles of the first magnet 142, thereby creating a pushing or pulling force on the first moving assembly 14 relative to the base 131. As a result, the first moving assembly 14 moves relative to the base 131, supported by multiple moving elements 113A.

Furthermore, this drives the first moving assembly 14 to produce reciprocating movement relative to the base 131 in the first direction Z. Thus, the imaging lens 12 is displaced via the first moving structure 11A, enabling the autofocus function of the camera structure 1.

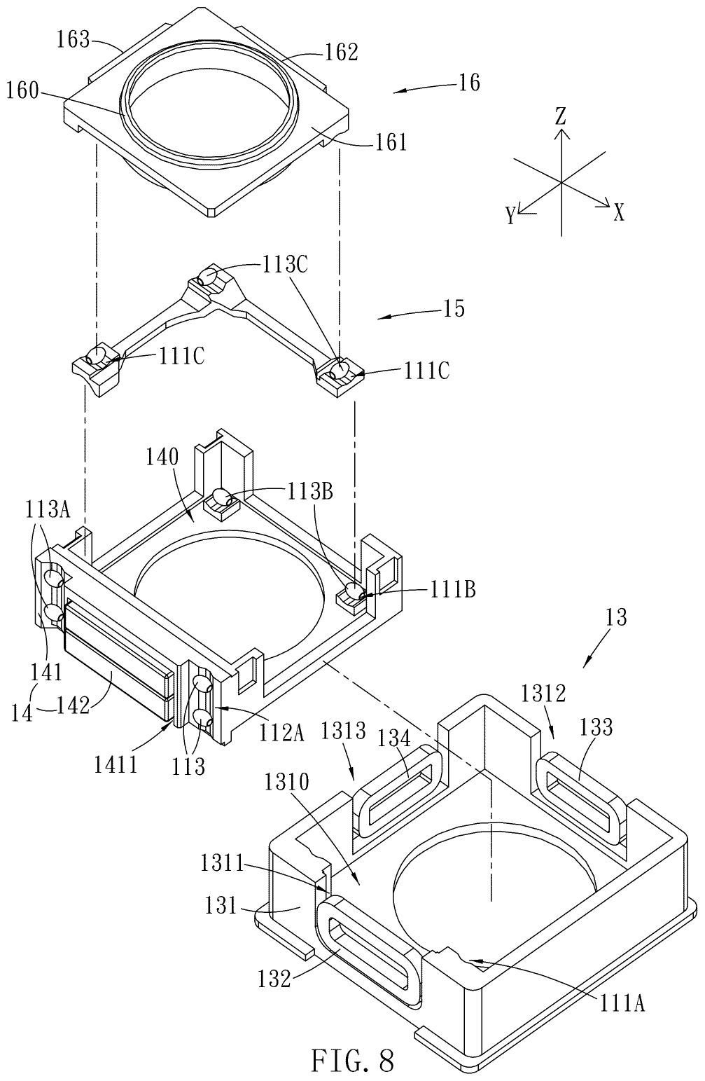

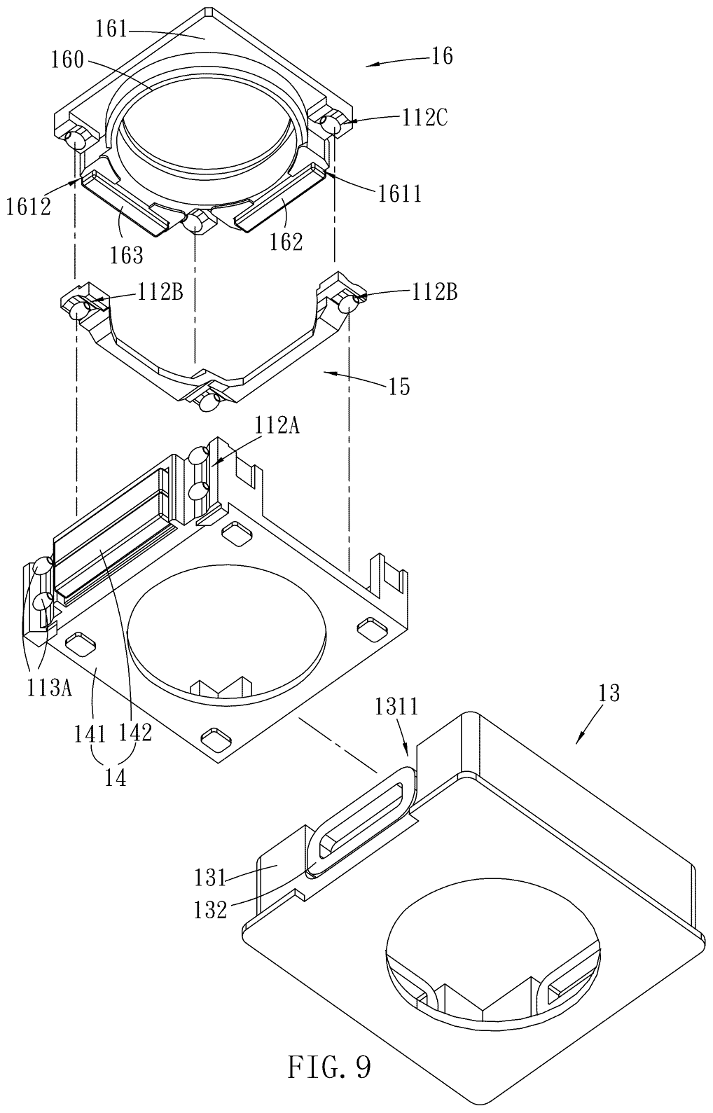

Please refer to FIG. 7 to FIG. 9. FIG. 7 is an enlarged view of area E in FIG. 6, FIG. 8 is a partially exploded perspective view of the first embodiment of the camera structure of the present invention, and FIG. 9 is another partially exploded perspective view of the first embodiment of the camera structure of the present invention. As shown in FIG. 7 to FIG. 9, the first embodiment further includes a second moving assembly 15, and the moving structure 11 includes a second moving structure 11B. The first moving assembly 14 has an accommodation concave slot 140 and the second moving assembly 15 is disposed within the accommodation concave slot 140 of the first moving assembly 14. A second moving structure 11B situated between the accommodation concave slot 140 of the first moving assembly 14 corresponds to the bottom portion of the second moving assembly 14. The first moving assembly 14 has a first moving portion 111B, and the second moving assembly 15 has a second moving portion 112B. The second moving structure 11B guides the second moving assembly 15 to move reciprocally in the second direction Y (horizontal direction) relative to the first moving assembly 14. The second direction Y and the first direction Z are perpendicular to each other.

As described above, in this embodiment, there are three moving elements 113B. The bottom of the accommodation concave slot 140 of the first moving assembly 14 has three first moving portions 111B. The second moving assembly 15 has an L-shaped structure, with the second moving portion 112B arranged at both ends and the L-corner of the second moving assembly 15. The three moving elements 113B form a movable supporting horizontal plane, and the three moving elements 113B are assembled between the second moving portion 112B of the second moving assembly 15 and the first moving portion 111B of the first moving assembly 14.

In this embodiment, the camera structure 1 further includes a lens base assembly 16. The moving structure 11 includes a third moving structure 11C. The lens base assembly 16 is disposed on the second moving assembly 15. A third moving structure 11C is located between the top portion of the second moving assembly 15 and to the bottom portion of the lens base assembly 16. The second moving assembly 15 has a first moving portion 111C. The lens base assembly 16 has a second moving portion 112C. The third moving structure 11C guides the lens base assembly 16 to move reciprocally in the third direction X (horizontal direction) relative to the second moving assembly 15. The third direction X and second direction Y are perpendicular to each other. Further, the third direction X and the first direction Z also are perpendicular to each other.

As described above, in this embodiment, there are moving elements 113C. The second moving assembly 15 has an L-shaped structure. The positions of the three moving elements 113C correspond to the positions of the three moving elements 113B. The three moving elements 113C are also arranged at both ends and the L-corner of the second moving assembly 15. The three moving elements 113C form a movable supporting horizontal plane. The lens base assembly 16 is the lens frame for assembling the imaging lens 12. The second moving portion 112C is disposed at the three corner positions of the bottom portion of the lens base assembly 16. The three moving elements 113C are assembled between the second moving assembly 15 and the lens base assembly 16.

In this embodiment, the second moving structure 11B and the third moving structure 11C are used to provide displacement in the horizontal direction. In the second moving structure 11B, multiple moving elements 113B have one end of the second surface 1121 facing inward. In the third moving structure 11C, multiple moving elements 113C also have one end of the second surface 1121 facing inward. Additionally, in this embodiment, the imaging lens 12 is disposed on the lens base assembly 16, wherein the lens base assembly 16 has an assembly hole 160. The imaging lens 12 can be fitted into the assembly hole 160 such that the imaging lens 12 can be moved via the base assembly 13, the first moving assembly 14, the second moving assembly 15, and the lens base assembly 16.

In this embodiment, the base assembly 13 includes a base 131 and a second coil 133. The second coil 133 is disposed on the base 131, wherein the slot side wall of the base accommodation concave slot 1310 of the base 131 further has a second notch 1312. The first notch 1311 and the second notch 1312 are located in different slot side walls of the base accommodation concave slot 1310. The second coil 133 is located within the second notch 1312. The lens base assembly 16 includes a lens base 161 and a second magnet 162. The second magnet 162 is disposed on the lens base 161. The lens base 161 has a second accommodation trough 1611, and the second magnet 162 is disposed within the second accommodation trough 1611. The position of the second notch 1312 corresponds to the position of the second accommodation trough 1611. Thus, the second magnet 162 corresponds to the second coil 133 and the magnetic pole direction of the second magnet 162 is arranged parallel to the second direction Y; i.e., the S pole and the N pole of the magnetic pole are aligned in a horizontal direction. When current passes through the second coil 133, the magnetic pole of the second coil 133 and the magnetic pole of the second magnet 162 interact with each other, resulting in either a pushing or pulling force on the second magnet 162 relative to the second coil 133. Consequently, the lens base assembly 16 moves in the second direction Y through the second moving structure 11B, which is situated between the second moving assembly 15 and the first moving assembly 14. Furthermore, this movement drives the lens base assembly 16 and the second moving assembly 15 to reciprocate relative to the first moving assembly 14 in a reciprocating movement in the second direction Y. Because the third moving structure 11C restricts and guides the lens base assembly 16 to reciprocate only relative to the second moving assembly 15 in the third direction X (as shown in FIG. 6 and FIG. 7), the lens base assembly 16 and the second moving assembly 15 do not move relative to each other in the second direction Y when the second coil 133 and the second magnet 162 interact to drive the lens base assembly 16 and the second moving assembly 15 to reciprocate relative to the first moving assembly 14 in the second direction Y.

Furthermore, the base assembly 13 includes a base 131 and a third coil 134. The third coil 134 is disposed on the base 131, wherein the slot side wall of the base accommodation concave slot 1310 of the base 131 further has a third notch 1313. The first notch 1311, the second notch 1312, and the third notch 1313 are respectively located on different slot side walls of the base accommodation concave slot 1310. The third coil 134 is disposed within the third notch 131. The lens base assembly 16 includes a lens base 161 and a third magnet 163. The third magnet 163 is disposed on the lens base 161, wherein the lens base 161 has a third accommodation trough 1612 and the third magnet 163 is disposed within the third accommodation trough 1612. The position of the third notch 1313 corresponds to the position of the third accommodation trough 1612. Thus, the third coil 134 corresponds to the third magnet 163 and the magnetic pole direction of the third magnet 163 is parallel to the third direction X. When an electric current passes through the third coil 134, the magnetic pole of the third coil 134 and the magnetic pole of the third magnet 163 interact with each other, generating either a pushing or pulling force between the third magnet 163 and the third coil 134. Consequently, the lens base assembly 16 is displaced in the third direction X by the third moving structure 11C. Furthermore, the lens base assembly 16 is driven to reciprocate in the third direction X relative to the second moving assembly 15. Because the second moving structure 11B restricts and guides the second moving assembly 15 to reciprocate only relative to the first moving assembly 14 in the second direction Y (as shown in FIG. 6 and FIG. 7), the second moving assembly 15 and the first moving assembly 14 do not move relative to each other in the third direction X when the third coil 134 and the third magnet 163 interact to drive the lens base assembly 16 to reciprocate relative to the second moving assembly 15 in the third direction X. This enables the imaging lens 12 to move via the second moving structure 11B and the third moving structure 11C, thus achieving the optical image stabilization (OIS) functionality of the camera structure 1.

In this embodiment, the moving structure 11 includes a first moving structure 11A, a second moving structure 11B, and a third moving structure 11C. The first moving structure 11A, the second moving structure 11B, and third moving structure C all have the same structure (as shown in FIG. 3). The first moving structure 11A is responsible for reciprocating movement in the first direction Z, the second moving structure 11B for reciprocating movement in the second direction Y, and the third moving structure 11C for reciprocating movement in the third direction X. The purpose of the moving structure 11, as described above, is to provide three-axis directional movement adjustments for the imaging lens 12.

Please refer back to FIG. 6. The camera structure 1 further includes a circuit board 17, and the circuit board 17 is disposed at a side of the base assembly 13. The circuit board 17 is disposed at a side of the first coil 132, the second coil 133, and the third coil 134. The circuit board 17 is electrically connected to the first coil 132, the second coil 133, and the third coil 134 respectively. The camera structure 1 further includes a spring plate 18. The spring plate 18 is disposed on the first moving assembly 14, and the spring plate 18 abuts against the top of the lens base assembly 16. The spring plate 18 is arranged along three sides of the first moving assembly 14. A fixing part 181 is extended downward from an edge of the spring plate 18. In some embodiments, there are three fixing parts 181 respectively extended from three edges of the spring plate 18. The first moving assembly 14 has a corresponding fixed trough 143, and the fixing part 181 of the spring plate 18 is fixed in the fixed trough 143 of the first moving assembly 14. The spring plate 18 can be used to confine the movement of the lens base assembly 16 corresponding to the first moving assembly 14 in at least one of the third direction X and the second direction Y. The spring plate 18 can be used to confine the movement range of the lens base assembly 16 and the imaging lens 12 in the first direction Z (the focusing movement range), as well as to ensure that the lens base assembly 16 is securely assembled within the first moving assembly 14.

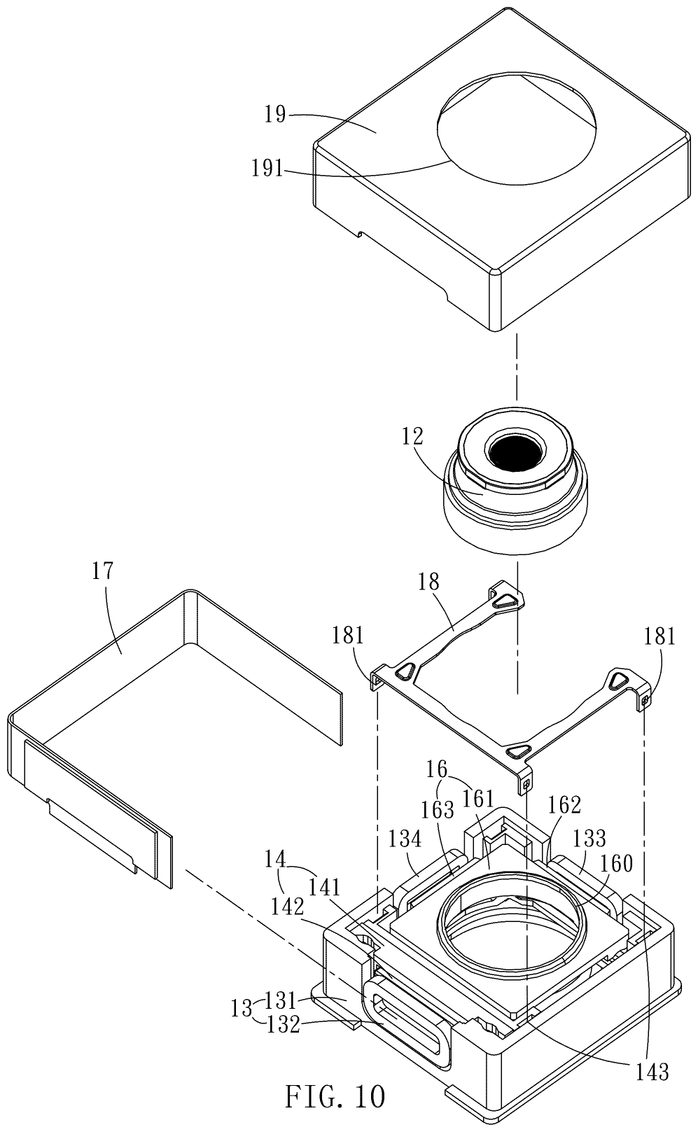

In addition, as shown in FIG. 10, the camera structure 1 further includes a protective cover 19, and the protective cover 19 has an orifice 191. The protective cover 19 is placed over the base assembly 13, sealing the first moving assembly 14, the second moving assembly 15, the lens base assembly 16, the circuit board 17, and the spring plate 18 within the base assembly 13, with the imaging lens 12 of the lens base assembly 16 extending through the orifice 191 of the protective cover 19.

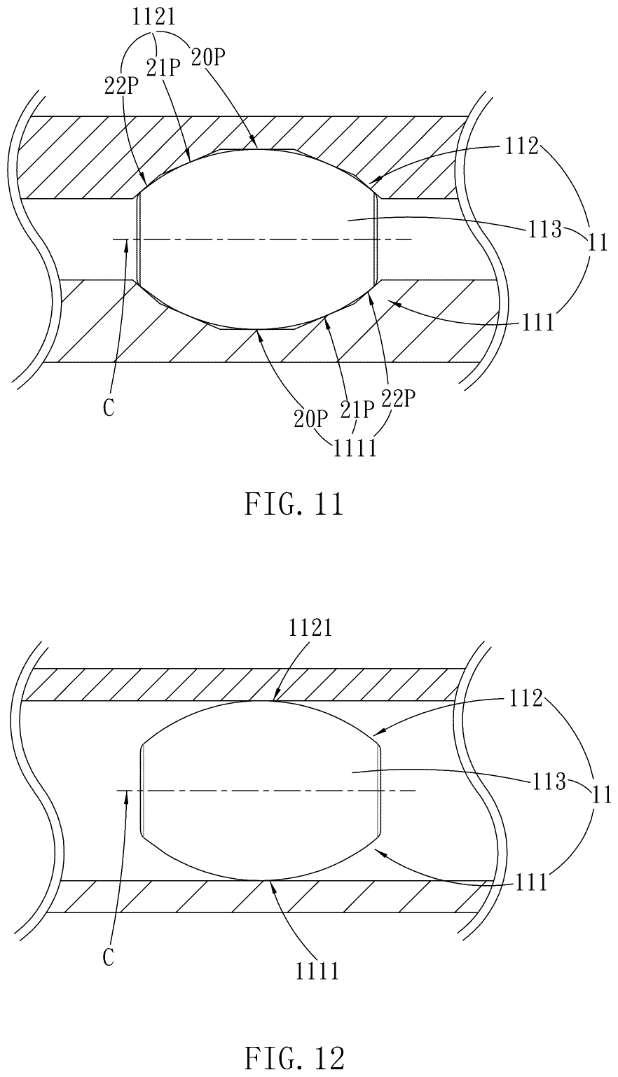

Please refer to FIG. 11. FIG. 11 is a schematic view of the second embodiment of the camera structure of the present invention; as shown in FIG. 11, the difference between this embodiment and the first embodiment lies in the shape of the first surface 1111 and the second surface 1121. In this embodiment, the shapes of the first surface 1111 and the second surface 1121 are symmetrical with the long axis C of the moving element 113. The following description will focus on the first surface 1111. In this embodiment, the first surface 1111 is composed of a bottom surface 20P, two first inclined planes 21P and two second inclined planes 22P. The inclination angles of the first inclined plane 21P and the second inclined plane 22P relative to the bottom surface are different. The bottom surface 20P connects sequentially with the two first inclined planes 21P and the two second inclined planes 22P. This configuration forms a polygonal concave surface based on the side profile of the moving element 113. As such, the moving element 113 has corresponding contact points with the bottom surface 20P and the two first inclined planes 21P and the two second inclined planes 22P of the first surface 1111 or the second surface 1121. In this embodiment, the polygonal concave surface has a greater number of contact points relative to the moving element 113, which can stabilize the sliding stability of the moving element 113.

Please refer to FIG. 12. FIG. 12 is a schematic view of the third embodiment of the camera structure of the present invention. As shown in FIG. 12, the difference between this embodiment and the first embodiment lies in the shape of the first surface 1111 and the second surface 1121. In this embodiment, the first surface 1111 and the second surface 1121 are planar shapes. The moving element 113 has a single contact point with each of the first surface 1111 and the second surface 1121. This embodiment provides fewer constraints on the moving element 113, allowing greater freedom of movement. The first surface 1111 and the second surface 1121 are parallel to the long axis C.

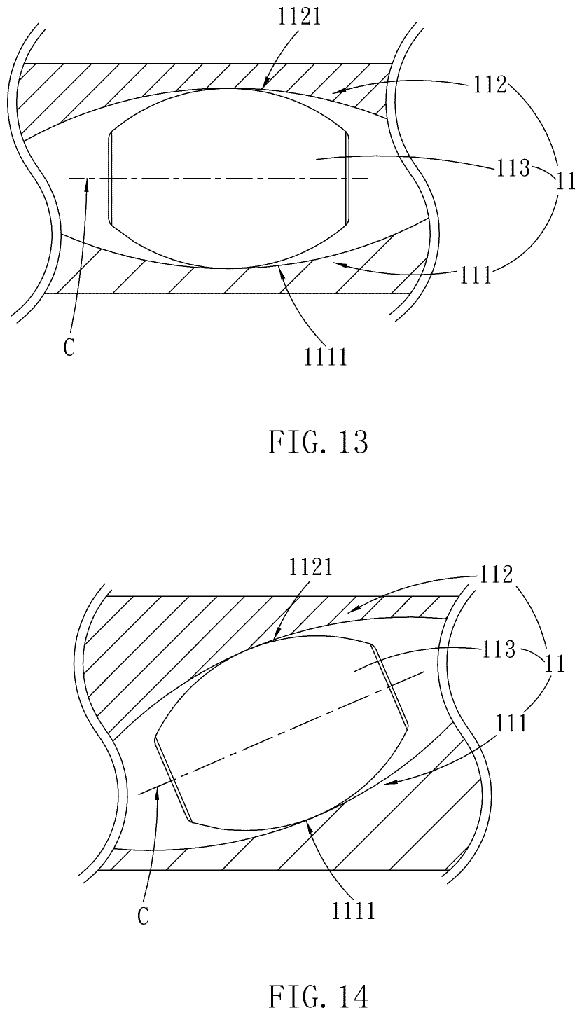

Please refer to FIG. 13. FIG. 13 is a schematic view of the fourth embodiment of the camera structure of the present invention. As shown in FIG. 13, the difference between this embodiment and the first embodiment lies in the shape of first surface 1111 and the second surface 1121. In this embodiment, the first surface 1111 and the second surface 1121 are arc-shaped. The moving element 113 has a single contact point with each of the first surface 1111 and the second surface 1121. The arc shapes of the first surface 1111 and the second surface 1121 closer to the side profile arc of the external surface 1132 of the moving element 113. Therefore, the contact area between the first surface 1111 and the second surface 1121 and the moving element 113 is larger than that in the third embodiment, which uses a planar shape. Additionally, the arc-shaped surfaces of the first surface 1111 and the second surface 1121 allow the moving element 113 to continue rolling at the low point of the arc during its movement. In some embodiments, the arc curvature of the first surface 1111 and the second surface 1121 is less than the arc curvature of the external surface 1132 of the moving element 113.

Please refer to FIG. 14. FIG. 14 is a schematic view of the fifth embodiment of the camera structure of the present invention. As shown in FIG. 14, the difference between this embodiment and the fourth embodiment lies in the arc angle of the first surface 1111 and the second surface 1121. In this embodiment, the first surface 1111 and the second surface 1121 have an arc shape, where both the first surface 1111 and the second surface 1121 are deflected by the same angle relative to the long axis C of the moving element 113. In other words, the first surface 1111 forms an angle with the wall surface of the outer wall of the base 131. The second surface 1121 forms an angle with the wall surface of the inner wall of the first moving assembly 14. As a result, the moving element 113 will also slide at an inclined angle. This embodiment does not restrict the deflection angle, which can be adjusted according to the user's needs.

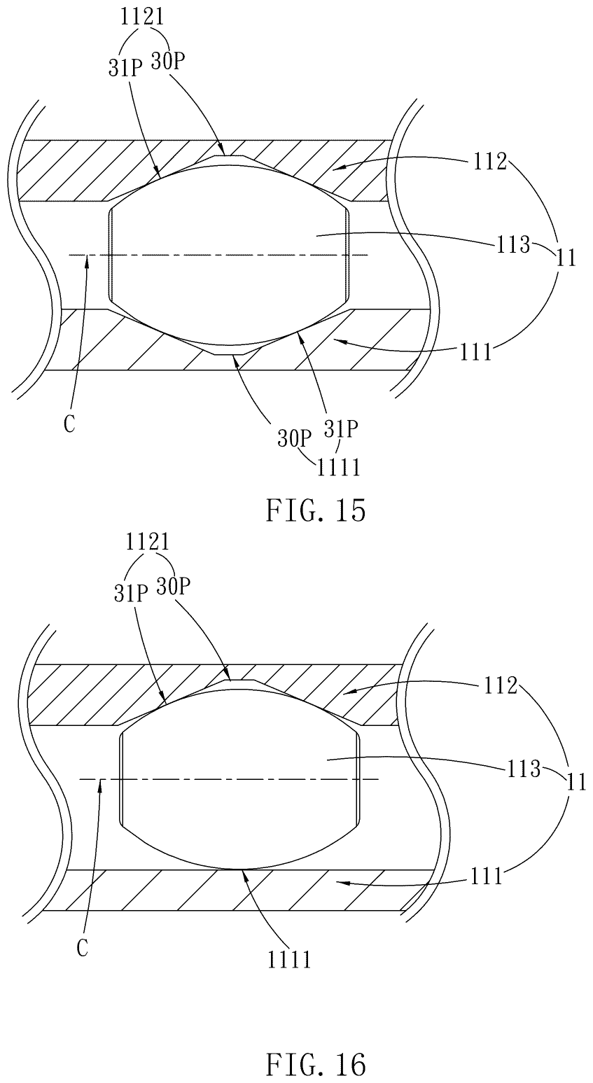

Please refer to FIG. 15. FIG. 15 is a schematic view of the sixth embodiment of the camera structure of the present invention. As shown in FIG. 15, this embodiment differs from the first embodiment in terms of the structural differences of the first surface 1111 and the second surface 1121. In this embodiment, the external surface 1132 of the moving element 113 has corresponding contact points relative to the two inclined planes 31P of the first surface 1111 and the second surface 1121, resulting in a total of four contact points between the external surface 1132 and the first surface 1111 as well as the second surface 1121. There is a gap between the bottom surface 30P of the first surface 1111 and the second surface 1121 relative to the external surface 1132 of the moving element 113; i.e., the external surface 1132 of the moving element 113 is suspended between the bottom surface 30P of the first surface 1111 and the second surface 1121. Furthermore, in this embodiment, the polygonal concave surfaces of the first surface 1111 and the second surface 1121 have multiple contact points relative to the moving element 113. The number of surfaces of the polygonal concave may be greater than or equal to the number of contact points of the moving element 113. In other words, the moving element 113 does not necessarily make full contact with all the surfaces of the polygonal concave, and this can be adjusted based on user needs. Thus, in this embodiment, the moving element 113 can reduce the number of contact points with the first surface 1111 and the second surface 1121, thereby reducing the rolling resistance of the moving element 113.

Please refer to FIG. 16. FIG. 16 is a schematic view of the seventh embodiment of the camera structure of the present invention. As shown in FIG. 16, this embodiment differs from the sixth embodiment in that the surface structure shape of one of the first surface 1111 and the second surface 1121 is different. In this embodiment, the first surface 1111 is planar, and the moving element 113 has a single contact point relative to the first surface 1111. In this embodiment, the surface structures of the first surface 1111 and the second surface 1121 are non-symmetrical with the surface structures of the long axis C. In other words, the number of contact points between the moving element 113 relative to the first surface 1111 and the second surface 1121 is also inconsistent. The first surface 1111 in this embodiment imposes fewer constraints on the moving element 113, allowing for greater freedom of movement. Conversely, the second surface 1121 imposes more constraints on the moving element; i.e., the moving element 113 has less freedom of movement. The above can be adjusted according to the user's needs. In this embodiment, the first surface 1111 is parallel to the long axis C. In various embodiments, the second surface 1121 is planar and also parallel to the long axis C, whereas the structure of the first surface 1111 corresponds to the shapes depicted in FIG. 3, FIG. 11, FIG. 13, or FIG. 15.

Some embodiments of the present invention provide a camera structure that uses an elliptical design for a moving element. The moving element abuts against the first surface, which is a first elliptical surface. The moving element abuts against the second surface, which is a second elliptical surface. This elliptical surface contact helps to distribute the contact stress more evenly, thereby reducing the frictional damage to the first surface and the second surface caused by the moving element.

It should also be noted that the terms “comprise”, “includes” or any other variation thereof are intended to cover non-exclusive inclusion, so that a process, method, product, or apparatus that includes a list of elements not only includes those elements but may also include other elements not expressly listed or inherent to such process, method, product, or apparatus. Without additional limitations, an element defined by the phrase “including a . . . ” does not exclude the presence of additional identical elements in the process, method, product, or apparatus that includes the element.

The above description illustrates and describes several embodiments of the present invention. However, it should be understood that the present invention is not limited to the forms disclosed herein and should not be construed as excluding other embodiments. It can be applied to various other combinations, modifications, and environments, and can be adapted within the scope of the inventive concepts presented here, based on the teachings provided or the knowledge and techniques in the relevant field. Any modifications and variations made by those skilled in the art that do not depart from the spirit and scope of the present invention are intended to be within the scope of the appended claims.

What is claimed is:

1. A camera structure, comprising:
a moving structure, comprising a first moving portion, a second moving portion, and a moving element, the moving element being disposed between the first moving portion and the second moving portion, and the moving element comprising two opposite end portions and an external surface located between the two end portions, a long axis of the moving element passing through the two end portions, the external surface surrounding the long axis and the external surface being a curved surface, the first moving portion having a first surface, the second moving portion having a second surface, the external surface of the moving element respectively abutting against the first surface and the second surface, and the moving structure being configured such that, when the first moving portion and the second moving portion are displaced relative to each other, the moving element moves along the first surface and the second surface; and
an imaging lens, configured to be displaced by the moving structure.

2. The camera structure as claimed in claim 1, wherein at least one of the first surface and the second surface is a plane, an arc surface based on a side profile of the external surface of the moving element or a polygonal concave surface based on the side profile of the external surface of the moving element.

3. The camera structure as claimed in claim 2, wherein the polygonal concave surface has multiple contact surfaces relative to the moving element.

4. The camera structure as claimed in claim 1, wherein at least one of the first surface and the second surface is parallel to the long axis of the moving element.

5. The camera structure as claimed in claim 1, wherein the first surface and the second surface are symmetrical with the long axis of the moving element.

6. The camera structure as claimed in claim 1, further comprising a base assembly and a first moving assembly, the first moving assembly being disposed within the base assembly, and the moving structure comprising a first moving structure, with the first moving structure being positioned between an inner wall of the base assembly corresponding to the outer wall of the first moving assembly, the base assembly having a first moving portion, the first moving assembly having a second moving portion, and the first moving structure guiding the first moving assembly to move reciprocally in a first direction relative to the base assembly.

7. The camera structure as claimed in claim 5, wherein the base assembly comprises a base and a first coil, the first coil being disposed on the base, the first moving assembly comprising a first moving body and a first magnet, the first magnet being disposed on the first moving body, the first coil corresponding to the first magnet, and a magnetic pole direction of the first magnet being parallel to the first direction.

8. The camera structure as claimed in claim 6, wherein the base has a base accommodation concave slot, with a slot side wall of the base accommodation concave slot having a first notch, the first coil being positioned within the first notch, the first moving body having a first accommodation trough, the first magnet being disposed within the first accommodation trough, and a position of the first notch corresponding to the position of the first accommodation trough.

9. The camera structure as claimed in claim 5, further comprising a second moving assembly, the moving structure comprising a second moving structure, the first moving assembly having an accommodation concave slot, the second moving assembly being disposed within the accommodation concave slot of the first moving assembly, with the second moving structure positioned between the accommodation concave slot of the first moving assembly corresponding to the bottom portion of the second moving assembly, the first moving assembly having a first moving portion, the second moving assembly having a second moving portion, the second moving structure guiding the second moving assembly to move reciprocally in a second direction relative to the first moving assembly, and the second direction and the first direction being perpendicular to each other.

10. The camera structure as claimed in claim 8, further comprising a lens base assembly, the moving structure comprising a third moving structure, the lens base assembly being disposed on the second moving assembly, the third moving structure being positioned between a top portion of the second moving assembly and the bottom portion of the lens base assembly, the second moving assembly having a first moving portion, the lens base assembly having a second moving portion, the third moving structure guiding the lens base assembly to move reciprocally in a third direction relative to the second moving assembly, and the third direction and the second direction being perpendicular to each other.

11. The camera structure as claimed in claim 9, the imaging lens being disposed on the lens base assembly.

12. The camera structure as claimed in claim 9, the base assembly comprising a base and a second coil, the second coil being disposed on the base, the lens base assembly comprising a lens base and a second magnet, the second magnet being disposed on the lens base, the second magnet corresponding to the second coil, and the magnetic pole direction of the second magnet being parallel to the second direction.

13. The camera structure as claimed in claim 11, wherein the base has a base accommodation concave slot, a slot side wall of the base accommodation concave slot further having a second notch, the second coil being positioned within the second notch, the lens base having a second accommodation trough, the second magnet being disposed within the second accommodation trough, and a position of the second notch corresponding to the position of the second accommodation trough.

14. The camera structure as claimed in claim 9, wherein the base assembly comprises a base and a third coil, the third coil being disposed on the base, the lens base assembly comprising a lens base and a third magnet, the third magnet being disposed on the lens base, the third magnet corresponding to the third coil, and the magnetic pole direction of the third magnet being parallel to the third direction.

15. The camera structure as claimed in claim 13, wherein the base has a base accommodation concave slot, the slot side wall of the base accommodation concave slot further having a third notch, the third coil being positioned within the third notch, the lens base having a third accommodation trough, the third magnet being disposed on the third accommodation trough, and the position of the third notch corresponding to the position of the third accommodation trough.

16. The camera structure as claimed in claim 9, further comprising a spring plate, the spring plate being disposed on the first moving assembly and abutting against the top of the lens base assembly.

17. The camera structure as claimed in claim 15, wherein the spring plate is arranged along a side of the first moving assembly, a fixing part is extended downward from an edge of the spring plate, the first moving assembly has a corresponded fixed trough, and the fixing part of the spring plate is fixed within the fixed trough of the first moving assembly correspondingly.

18. The camera structure as claimed in claim 1, further comprising a circuit board, the circuit board being arranged on a side of the base assembly, the circuit board being electrically connected to the first coil, the second coil, and the third coil respectively.
